(19) United States
(12) Patent Application Publication
(10) Pub. No.: US 2020/0392273 A1
(43) Pub. Date: Dec. 17, 2020

(54) SILYL-CONTAINING ACRYLATES AND DEGRADABLE RADICAL-CURED NETWORKS THEREOF

(71) Applicant: The Government of the United States of America, as represented by the Secretary of the Navy, Arlington, VA (US)

(72) Inventors: Erick B. Iezzi, Mars, PA (US); Eugene Camerino, Dumfries, VA (US); Grant C. Daniels, Lorton, VA (US); James H. Wynne, Alexandria, VA (US)

(73) Assignee: The Government of the United States of America, as represented by the Secretary of the Navy, Arlington, VA (US)

(21) Appl. No.: 16/901,638

(22) Filed: Jun. 15, 2020

Related U.S. Application Data
(60) Provisional application No. 62/861,486, filed on Jun. 14, 2019.

(51) Int. Cl. C08F 222/16; C07F 7/08

(52) U.S. Cl. CPC C08F 222/16; C07F 7/081

(57) ABSTRACT

Disclosed is a network made by a method of: polymerizing a silyl-containing acrylate or methacrylate monomer, optionally copolymerized with a second acrylate or methacrylate monomer. The silyl-containing monomer has two or more acrylate or methacrylate groups. The second monomer contains no silyl groups. The second monomer comprises a urethane group, an ether group, an ester group, a urea group, an amide group, a thioether group, a hydroxyl group, or is an alkyl acrylate. The copolymerization is via radical-initiated polymerization of the acrylate or methacrylate groups. The network may be degradable upon exposure to a fluoride salt, an acid, or a base.

This application claims the benefit of U.S. Provisional Application No. 62/861,486, filed on Jun. 14, 2019. The provisional application and all other publications and patent documents referred to throughout this nonprovisional application are incorporated herein by reference.

### TECHNICAL FIELD

The present disclosure is generally related to silyl-containing cross-linked networks.

### DESCRIPTION OF RELATED ART

Energy-cured networks are formed by the initiation of radicals with UV radiation, heat, or an electron beam, followed by propagation of the radicals via reaction with acrylate, methacrylate or vinyl functional molecules to form polymeric chains. The propagation reaction occurs quickly, giving rise to an extensive network of covalently bound cross-links and a solidified material within seconds to a few minutes. The high cross-link density of these networks results in materials that possess excellent thermal and chemical resistance, which enables their use in applications such as coatings, adhesives, and printing inks. However, these networks are simultaneously difficult to degrade unless harsh chemical treatments, mechanical abrasion, or thermal ablation are utilized. To date, only a few degradable UV-cured networks have been reported, and most rely on elevated temperatures and/or acidic solutions to facilitate bond breakage.

### BRIEF SUMMARY

Disclosed herein is a network made by a method comprising: copolymerizing a silyl-containing acrylate or methacrylate monomer with a second acrylate or methacrylate monomer. The silyl-containing monomer has two or more acrylate groups. The second monomer contains no silyl groups. The second monomer comprises a urethane group, an ether group, an ester group, a urea group, an amide group, a thioether group, a hydroxyl group, or is an alkyl acrylate. The copolymerization is via radical-initiated polymerization of the acrylate or methacrylate groups.

Also disclosed herein is a network made by a method comprising: polymerizing a silyl-containing acrylate or methacrylate monomer. The silyl-containing monomer is SiRₙ[(CH₂)₂—O—CO—CH═CH₂]₄₋ₙ; SiRₙ[(CH₂)₂—O—CO—C(CH₃)═CH₂]₄₋ₙ; SiRₙ[(CH₂)₄—O—CO—CH═CH₂]₄₋ₙ; SiRₙ[(CH₂)₄—O—CO—C(CH₃)═CH₂]₄₋ₙ; SiRₙ[(CH₂)ₓO—CO—O—CH₂—CH₂—O—CO—CH═CH₂]₄₋ₙ; SiRₙ[(CH₂)ₓO—CO—O—CH₂—CH₂—O—CO—C(CH₃)═CH₂]₄₋ₙ; SiRₙ[(CH₂)ₓO—CO—O—CH₂—CH₂—CH₂—O—CO—CH═CH₂]₄₋ₙ; SiRₙ[(CH₂)ₓO—CO—O—CH₂—CH₂—CH₂—O—CO—C(CH₃)═CH₂]₄₋ₙ; SiRₙ[(CH₂)ₓ—O—CO—N(R)—CH₂—CH₂—O—CO—C(CH₃)═CH₂]₄₋ₙ; SiRₙ[(CH₂)ₓ—O—CO—N(R)—CH₂—CH₂—O—CO—CH═CH₂]₄₋ₙ; SiRₙ[(CH₂)ₓ—O—CO—N(R)—CH₂—CH₂—CH₂—O—CO—CH═CH₂]₄₋ₙ; or SiRₙ[(CH₂)ₓ—O—CO—N(R)—CH₂—CH₂—CH₂—O—CO—C(CH₃)═CH₂]₄₋ₙ. The value n is 0, 1, or 2. Each x is 1, 2, 3, or 4. Each R is alkyl or aryl. The polymerization is via radical-initiated polymerization of the acrylate or methacrylate groups.

Also disclosed herein are the above methods of making the networks.

Also disclosed herein is a compound having the formula SiRₙ[(CH₂)ₓ—O—CO—C(R′)═CH₂]₄₋ₙ. The value n is 0, 1, or 2. Each x is 2 or 4. Each R is alkyl or aryl. Each R′ is H or CH₃.

Also disclosed herein is a compound having the formula SiRₙ[(CH₂)ₓ—O—CO—Y—CH₂—CH₂—O—CO—CR′═CH₂]₄₋ₙ or SiRₙ[(CH₂)ₓ—O—CO—Y—CH₂—CH₂—CH₂—O—CO—CR′═CH₂]₄₋ₙ. The value n is 0, 1, or 2. Each x is 1, 2, 3, or 4. Each Y is —O— or —N(R)—. Each R′ is H or CH₃. Each R is alkyl or aryl.

### BRIEF DESCRIPTION OF THE DRAWINGS

A more complete appreciation will be readily obtained by reference to the following Description of the Example Embodiments and the accompanying drawings.

FIG. 1 shows example silyl-containing monomers.

FIG. 2 shows example comonomers.

FIG. 3 shows a scheme for breaking down the networks.

### DETAILED DESCRIPTION OF EXAMPLE EMBODIMENTS

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

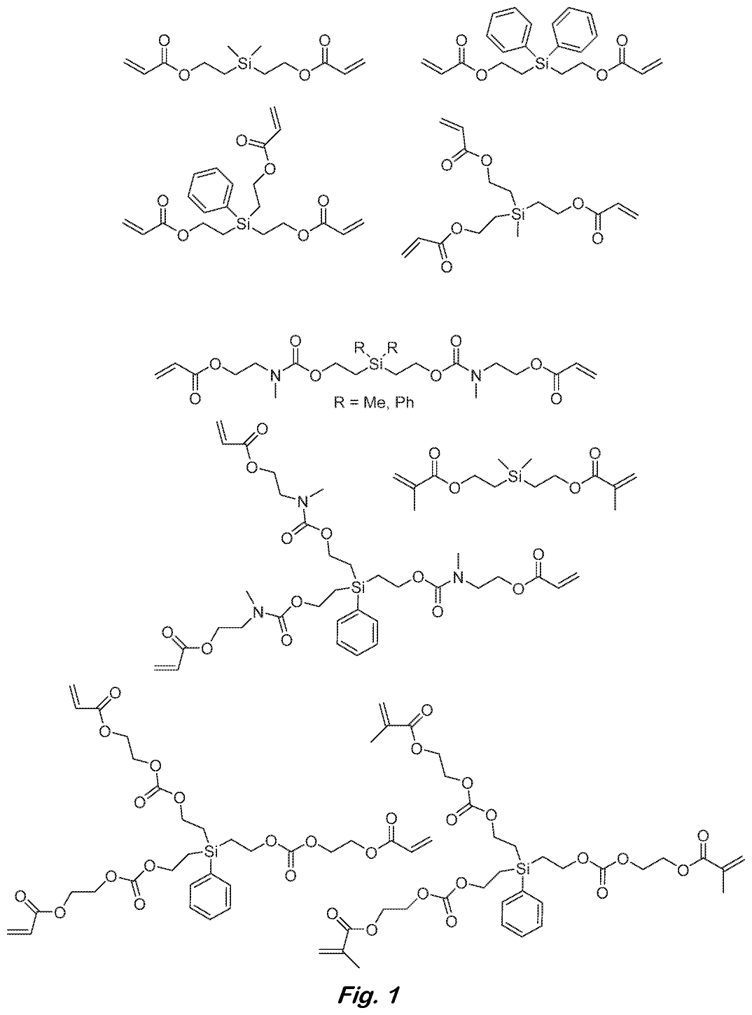

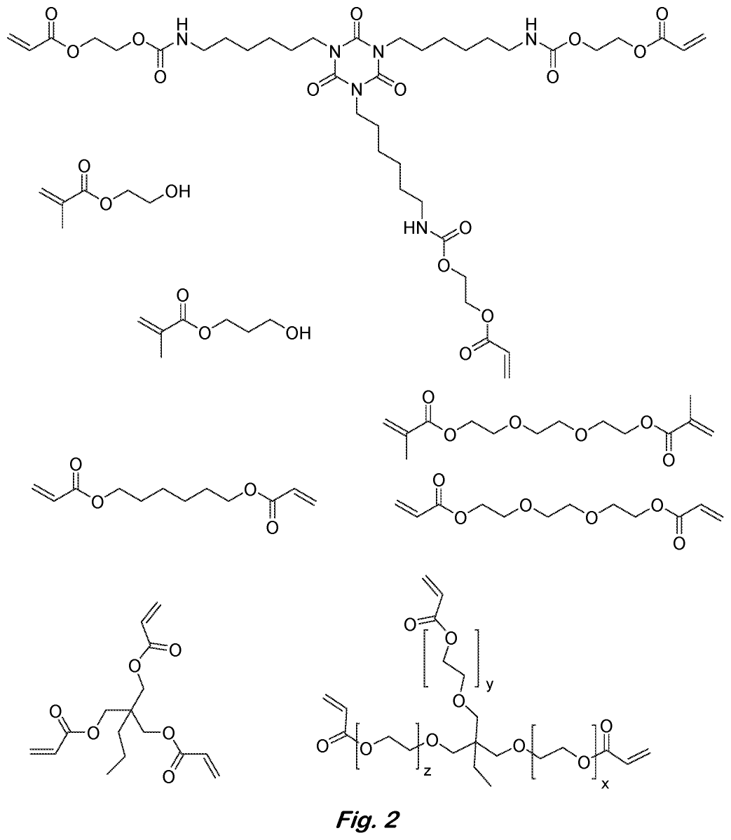

Disclosed are acrylate- and methacrylate-terminated silyl-containing molecules and their use in degradable radical-cured networks. The silyl-containing molecules can be di-, tri-, or tetrafunctionalized with acrylate or methacrylate groups, whereas the chains stemming from the central silicon atom can be of various length and composition. Acrylate- and methacrylate-terminated molecules typically used in these systems are shown in FIG. 1. These molecules can be used as the sole acrylate or methacrylate source in the radical-cured network, or they can be mixed with a non-silyl-containing acrylate- or methacrylate-functional molecule, such as the acrylates shown in FIG. 2.

Silyl-containing radical-cured coatings are typically formed by adding an initiator, such as 2,4,6-trimethylbenzoyl-diphenylphosphineoxide or dimethylhydroxyacetophenone, followed by application to a substrate via spraying or a drawdown bar. Once all volatiles have evaporated the coating is exposed to ultraviolet (e.g., UV-B or UV-A) radiation, heat, or an electron beam for seconds to minutes in order to cross-link the network and form a solid coating.

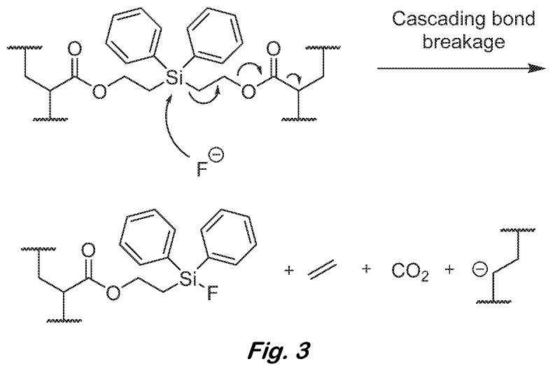

These networks can be selectively degraded at room temperature with a fluoride ion stimulus, such as fluoride salts in solution. Examples of fluoride salts include tetrabutylammonium fluoride (TBAF), cesium fluoride (CsF), and stannous fluoride (SnF₂), whereas the solvent may be water, tetrahydrofuran (THF), acetone, methanol, isopropanol, others, or a combination. As shown in FIG. 3, the network is degraded by reaction of fluoride ion with the silicon atom in the cross-linked chains, followed by cleavage of the Si—C bond and the release of ethylene and carbon dioxide via cascading bond cleavage. The presence of other degradable bonds and linkages between silicon and the terminal acrylate groups can result in the formation of small cyclic molecules and other volatiles.

A variety of silyl monomers having at least two acrylate or methacrylate groups may be used. Some examples are shown in FIG. 1. Examples also include, but are not limited to, SiRₙ[(CH₂)₂—O—CO—C(R′)═CH₂]₄₋ₙ, SiRₙ[(CH₂)₄—O—CO—C(R′)═CH₂]₄₋ₙ, SiRₙ[(CH₂)ₓ—O—CO—Y—CH₂—CH₂—O—CO—C(R)═CH₂]₄₋ₙ, and SiRₙ[(CH₂)ₓ—O—CO—Y—CH₂—CH₂—CH₂—O—CO—C(R)═CH₂]₄₋ₙ. The value n is 0, 1, or 2; each x is 1, 2, 3, or 4; each Y is —O— or —N(R)—; each R′ is H or CH₃; and R is alkyl, methyl, aryl, or phenyl. More than one different silyl monomer may be included.

Optionally, a second acrylate or methacrylate monomer may be included. The second monomer is free of silyl groups and comprises a urethane group, an ether group, an ester group, a urea group, an amide group, a thioether group, a hydroxyl group, or is an alkyl acrylate. It has one or more acrylate or methacrylate groups. Some examples are shown in FIG. 2. Examples also include, but are not limited to, HO—(CH₂)ₓ—O—CO—CH═CH₂; HO—(CH₂)ₓ—O—CO—C(CH₃)═CH₂, CH₂═CH—CO—O—(CH₂)ₓ—O—CO—CH═CH₂, CH₂═CH—CO—O—(CH₂—CH₂—O)ₓ—CO—CH═CH₂, CH₂═C(CH₃)—CO—O—(CH₂—CH₂—O)ₓ—CO—C(CH₃)═CH₂, CH₃(CH₂)_{y}C[CH₂—O—CO—CH═CH₂]₃, and CH₃(CH₂)_{y}C[CH₂—O—(CH₂—CH₂—O)ₓ—CO—CH═CH₂]₃. Each x is an integer from 1 to 10, and y is 1 or 2. More than one different second monomer may be included.

The polymerization or copolymerization to a cross-linked network is by radical-initiated polymerization of the carbon-carbon double bonds in the acrylate or methacrylate groups. Such polymerization techniques are known in the art. The initiation may be, for example, by UV irradiation, heat, or electron beam, and may include a chemical initiator mixed with the monomer(s).

When it is desired that the cross-linked network be degraded, such as when a coating is to be replaced, it can be degraded with a fluoride salt, an acid, or a base. Suitable fluoride salts include, but are not limited to, tetrabutylammonium fluoride, tetramethylammonium fluoride, stannous fluoride, potassium fluoride, and sodium fluoride. Such methods are described in US Pat. Appl. Pub. No. 2018/0171061. As shown in FIG. 3, the fluoride ion breaks the silicon-carbon bond. Through a series of cascade bond cleavages, the result is the production of small volatile molecules and non-cross-linked polymer chains that are easier to solubilize and remove.

The alkyl chain between the silicon atom and the acrylate or methacrylate group may be methylene, ethylene, propylene, or butylene. When methylene is used the Si—C bond can be cleaved, but volatile molecules are not released. When ethylene is used the Si—C bond can be cleaved, followed by the generation of volatile ethene and carbon dioxide. When propylene is used the Si—C bond can be cleaved, followed by the formation of 4-butyrolactone instead of ethene and carbon dioxide. When butylene is used the Si—C bond can be cleaved, followed by the formation of 5-valerolactone instead of ethene and carbon dioxide.

A potential advantage of the disclosed networks is they allow UV-curable networks, such as coatings, to be rapidly degraded and removed on-demand without affecting the underlying polymeric or metallic substrate. This cannot be accomplished using current removal methods. They may also be polymerized and spun into fibers for making clothing, bandages, etc. that rapidly degrade, or for forming objects via 3D-printing.

The following examples are given to illustrate specific applications. These specific examples are not intended to limit the scope of the disclosure in this application.

### Example 1

Synthesis of silyl-containing UV-cured network A silyl-containing UV-cured network was formed by mixing 3.07 g of synthesized (diphenylsilanediyl)bis(ethane-2,1-diyl) diacrylate (FIG. 1), 5.54 g of an 80 wt. % solution of synthesized urethane-acrylate (FIG. 2) in 0.75 g of tert-butyl acetate (available from Sigma-Aldrich), and 0.23 g Genocure LTD photoinitiator blend (available from Rahn USA Corp.). The mixture was then applied to tinplate panels using 3 and 6 mil drawdown bars. The coatings were allowed to flash for 20 minutes, then were cured by irradiating with a Uvitron PortaRay 400 Watt lamp at 5 inches from the surface for 5 minutes.

Obviously, many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

What is claimed is:

1. A network made by a method comprising:
copolymerizing a silyl-containing acrylate or methacrylate monomer with a second acrylate or methacrylate monomer;
wherein the silyl-containing monomer has two or more acrylate or methacrylate groups;
wherein the second monomer contains no silyl groups;
wherein the second monomer comprises a urethane group, an ether group, an ester group, a urea group, an amide group, a thioether group, a hydroxyl group, or is an alkyl acrylate; and
wherein the copolymerization is via radical-initiated polymerization of the acrylate or methacrylate groups.

2. The network of claim 1, wherein the silyl-containing monomer is
SiRₙ[(CH₂)ₓO—CO—CH═CH₂]₄₋ₙ; SiRₙ[(CH₂)ₓ—O—CO—C(CH₃)═CH₂]₄₋ₙ;
SiRₙ[(CH₂)ₓ—O—CO—O—CH₂—CH₂—O—CO—CH═CH₂)]₄₋ₙ;
SiRₙ[(CH₂)ₓO—CO—O—CH₂—CH₂—O—CO—C(CH₃)═CH₂]₄₋ₙ;
SiRₙ[(CH₂)ₓO—CO—O—CH₂—CH₂—CH₂—O—CO—CH═CH₂]₄₋ₙ;
SiRₙ[(CH₂)ₓO—CO—O—CH₂—CH₂—CH₂—O—CO—C(CH₃)═CH₂]₄₋ₙ;
SiRₙ[(CH₂)ₓ—O—CO—N(R)CH₂—CH₂—O—CO—CH═CH₂]₄₋ₙ;
SiRₙ[(CH₂)ₓ—O—CO—N(R)CH₂—CH₂—O—CO—C(CH₃)═CH₂]₄₋ₙ;
SiRₙ[(CH₂)ₓ—O—CO—N(R)—CH₂—CH₂—CH₂—O—CO—CH═CH₂]₄₋ₙ; or
SiRₙ[(CH₂)ₓ—O—CO—N(R)—CH₂—CH₂—CH₂—O—CO—C(CH₃)═CH₂]₄₋ₙ;
wherein n is 0, 1, or 2;
wherein each x is 1, 2, 3, or 4; and
wherein each R is alkyl or aryl.

3. The network of claim 1, wherein the second monomer is

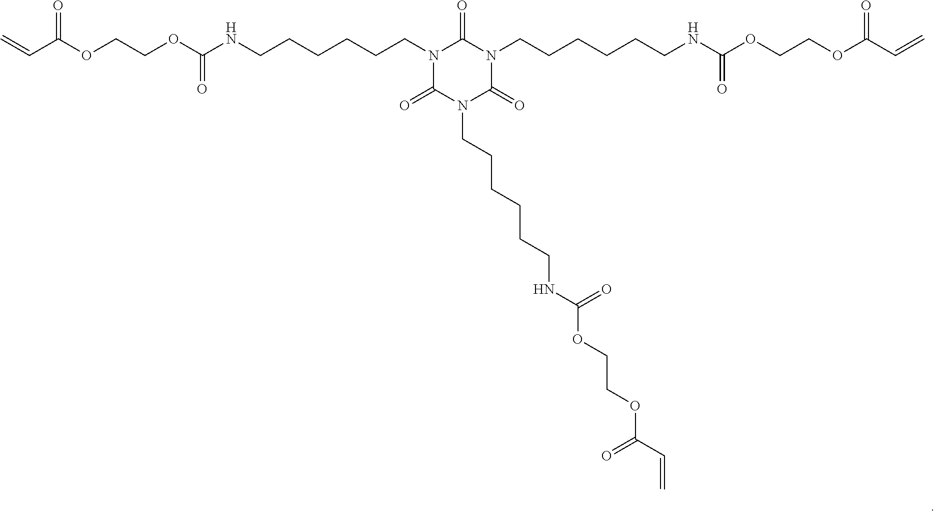 [SMILES: C=CC(=O)OCCOC(=O)NCCCCCCn1c(=O)n(CCCCCCNC(=O)OCCOC(=O)C=C)c(=O)n(CCCCCCNC(=O)OCCOC(=O)C=C)c1=O]

4. The network of claim 1, wherein the second monomer is HO—(CH₂)ₓ—O—CO—CH═CH₂;
HO—(CH₂)ₓ—O—CO—C(CH₃)═CH₂; CH₂═CH—CO—O—(CH₂)ₓO—CO—CH═CH₂;
CH₂═CH—CO—O—(CH₂—CH₂—O)ₓ—CO—CH═CH₂;
CH₂═C(CH₃)—CO—O—(CH₂—CH₂—O)ₓ—CO—C(CH₃)═CH₂;
CH₃(CH₂)_{y}C[CH₂—O—CO—CH═CH₂]₃; or
CH₃(CH₂)_{y}C[CH₂—O—(CH₂—CH₂—O)ₓ—CO—CH═CH₂]₃;
wherein each x is an integer from 1 to 10; and
wherein y is 1 or 2.

5. A method comprising:
reacting the network of claim 1 with a fluoride salt, an acid, or a base to cleave the silicon-carbon bonds in the network.

6. The method of claim 5, wherein the fluoride salt is tetrabutylammonium fluoride, tetramethylammonium fluoride, cesium, fluoride, stannous fluoride, potassium fluoride, or sodium fluoride.

7. A network made by a method comprising:
polymerizing a silyl-containing acrylate or methacrylate monomer;
wherein the silyl-containing monomer is one or more of
SiRₙ[(CH₂)₂—O—CO—CH═CH₂]₄₋ₙ; SiRₙ[(CH₂)₂—O—CO—C(CH₃)═CH₂]₄₋ₙ;
SiRₙ[(CH₂)₄—O—CO—CH═CH₂]₄₋ₙ; SiRₙ[(CH₂)₄—O—CO—C(CH₃)═CH₂]₄₋ₙ;
SiRₙ[(CH₂)ₓO—CO—O—CH₂—CH₂—O—CO—CH═CH₂]₄₋ₙ;
SiRₙ[(CH₂)ₓO—CO—O—CH₂—CH₂—O—CO—C(CH₃)═CH₂]₄₋ₙ;
SiRₙ[(CH₂)ₓO—CO—O—CH₂—CH₂—CH₂—O—CO—CH═CH₂]₄₋ₙ;
SiRₙ[(CH₂)ₓO—CO—O—CH₂—CH₂—CH₂—O—CO—C(CH₃)═CH₂]₄₋ₙ;
SiRₙ[(CH₂)ₓ—O—CO—N(R)CH₂—CH₂—O—CO—C(CH₃)═CH₂]₄₋ₙ;
SiRₙ[(CH₂)ₓ—O—CO—N(R)CH₂—CH₂—O—CO—CH═CH₂]₄₋ₙ;
SiRₙ[(CH₂)ₓ—O—CO—N(R)—CH₂—CH₂—CH₂—O—CO—CH═CH₂]₄₋ₙ; or
SiRₙ[(CH₂)ₓ—O—CO—N(R)—CH₂—CH₂—CH₂—O—CO—C(CH₃)═CH₂]₄₋ₙ;
wherein n is 0, 1, or 2;
wherein each x is 1, 2, 3, or 4;
wherein each R is alkyl or aryl; and
wherein the polymerization is via radical-initiated polymerization of the acrylate or methacrylate groups.

8. A method comprising:
reacting the network of claim 7 with a fluoride salt, an acid, or a base to cleave the silicon-carbon bonds in the network.

9. The method of claim 8, wherein the fluoride salt is tetrabutylammonium fluoride, tetramethylammonium fluoride, cesium fluoride, stannous fluoride, potassium fluoride, or sodium fluoride.

10. A method comprising:
copolymerizing a silyl-containing acrylate or methacrylate monomer with a second acrylate or methacrylate monomer;
wherein the silyl-containing monomer has two or more acrylate or methacrylate groups;
wherein the second monomer contains no silyl groups;
wherein the second monomer comprises a urethane group, an ether group, an ester group, a urea group, an amide group, a thioether group, a hydroxyl group, or is an alkyl acrylate; and
wherein the copolymerization is via radical-initiated polymerization of the acrylate or methacrylate groups.

11. The method of claim 10, wherein the silyl-containing monomer is
SiRₙ[(CH₂)ₓO—CO—CH═CH₂]₄₋ₙ; SiRₙ[(CH₂)ₓ—O—CO—C(CH₃)═CH₂]₄₋ₙ;
SiRₙ[(CH₂)ₓO—CO—O—CH₂—CH₂—O—CO—CH═CH₂]₄₋ₙ;
SiRₙ[(CH₂)ₓO—CO—O—CH₂—CH₂—O—CO—C(CH₃)═CH₂]₄₋ₙ;
SiRₙ[(CH₂)ₓO—CO—O—CH₂—CH₂—CH₂—O—CO—CH═CH₂]₄₋ₙ;
SiRₙ[(CH₂)ₓO—CO—O—CH₂—CH₂—CH₂—O—CO—C(CH₃)═CH₂]₄₋ₙ;
SiRₙ[(CH₂)ₓ—O—CO—N(R)CH₂—CH₂—O—CO—C(CH₃)═CH₂]₄₋ₙ;
SiRₙ[(CH₂)ₓ—O—CO—N(R)CH₂—CH₂—O—CO—CH═CH₂]₄₋ₙ;
SiRₙ[(CH₂)ₓ—O—CO—N(R)—CH₂—CH₂—CH₂—O—CO—CH═CH₂]₄₋ₙ; or
SiRₙ[(CH₂)ₓ—O—CO—N(R)—CH₂—CH₂—CH₂—O—CO—C(CH₃)═CH₂]₄₋ₙ;
wherein n is 0, 1, or 2;
wherein each x is 1, 2, 3, or 4; and
wherein each R is alkyl or aryl.

12. The method of claim 10, wherein the second monomer is

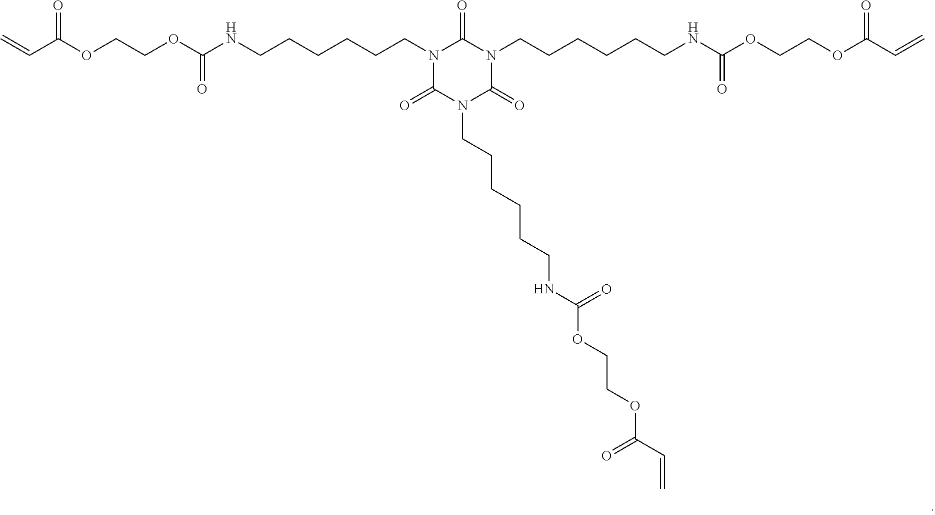 [SMILES: C=CC(=O)OCCOC(=O)NCCCCCCn1c(=O)n(CCCCCCNC(=O)OCCOC(=O)C=C)c(=O)n(CCCCCCNC(=O)OCCOC(=O)C=C)c1=O]

13. The method of claim 10, wherein the second monomer is HO—(CH₂)ₓO—CO—CH═CH₂;
HO—(CH₂)ₓ—O—CO—C(CH₃)═CH₂; CH₂═CH—CO—O—(CH₂)ₓO—CO—CH═CH₂;
CH₂═CH—CO—O—(CH₂—CH₂—O)ₓ—CO—CH═CH₂;
CH₂═C(CH₃)—CO—O—(CH₂—CH₂—O)ₓ—CO—C(CH₃)═CH₂;
CH₃(CH₂)_{y}C[CH₂—O—CO—CH═CH₂]₃; or
CH₃(CH₂)_{y}C[CH₂—O(CH₂—CH₂—O)ₓ—CO—CH═CH₂]₃;
wherein each x is an integer from 1 to 10; and
wherein y is 1 or 2.

14. The method of claim 10, wherein the copolymerization is UV-initiated.

15. A method comprising:
polymerizing a silyl-containing acrylate or methacrylate monomer;
wherein the silyl-containing monomer is one or more of
SiRₙ[(CH₂)₂—O—CO—CH═CH₂]₄₋ₙ; SiRₙ[(CH₂)₂—O—CO—C(CH₃)═CH₂]₄₋ₙ;
SiRₙ[(CH₂)₄—O—CO—CH═CH₂]₄₋ₙ; SiRₙ[(CH₂)₄O—CO—C(CH₃)═CH₂]₄₋ₙ;
SiRₙ[(CH₂)ₓO—CO—O—CH₂—CH₂—O—CO—CH═CH₂]₄₋ₙ;
SiRₙ[(CH₂)ₓO—CO—O—CH₂—CH₂—O—CO—C(CH₃)═CH₂]₄₋ₙ;
SiRₙ[(CH₂)ₓO—CO—O—CH₂—CH₂—CH₂—O—CO—CH═CH₂]₄₋ₙ;
SiRₙ[(CH₂)ₓO—CO—O—CH₂—CH₂—CH₂—O—CO—C(CH₃)═CH₂]₄₋ₙ;
SiRₙ[(CH₂)ₓ—O—CO—N(R)CH₂—CH₂—O—CO—CH═CH₂]₄₋ₙ;
SiRₙ[(CH₂)ₓ—O—CO—N(R)CH₂—CH₂—O—CO—C(CH₃)═CH₂]₄₋ₙ;
SiRₙ[(CH₂)ₓ—O—CO—N(R)—CH₂—CH₂—CH₂—O—CO—CH═CH₂]₄₋ₙ; or
SiRₙ[(CH₂)ₓ—O—CO—N(R)—CH₂—CH₂—CH₂—O—CO—C(CH₃)═CH₂]₄₋ₙ;
wherein n is 1 or 2;
wherein each x is 1, 2, 3, or 4;
wherein each R is alkyl or aryl; and
wherein the copolymerization is via radical-initiated polymerization of the acrylate or methacrylate groups.

16. The method of claim 15, wherein the polymerization is UV-initiated.

17. A compound having the formula
SiRₙ[(CH₂)ₓ—O—CO—C(R′)═CH₂]₄₋ₙ;
wherein n is 0, 1, or 2;
wherein each x is 2 or 4;
wherein each R′ is H or CH₃; and
wherein each R is alkyl or aryl.

18. A compound having the formula
SiRₙ[(CH₂)ₓ—O—CO—Y—CH₂—CH₂—O—CO—C(R)═CH₂]₄₋ₙ or
SiRₙ[(CH₂)ₓ—O—CO—Y—CH₂—CH₂—CH₂—O—CO—C(R)═CH₂]₄₋ₙ;
wherein n is 0, 1, or 2;
wherein each x is 1, 2, 3, or 4;
wherein each Y is —O— or —N(R)—;
wherein each R′ is H or CH₃; and
wherein each R is alkyl or aryl.
